(19) United States
(12) Patent Application Publication
(10) Pub. No.: US 2026/0147165 A1
(43) Pub. Date: May 28, 2026

(54) MULTI-CHANNEL OPTICAL FIBER TRANSMISSION INTERFACE AND MANUFACTURING METHOD OF THE SAME

(71) Applicant: AuthenX Inc., Hsinchu County (TW)

(72) Inventors: Sheng-Fu LIN, Hsinchu County (TW); Jenq-Yang CHANG, Hsinchu County (TW); Mao-Jen WU, Hsinchu County (TW)

(73) Assignee: AuthenX Inc., Hsinchu County (TW)

(21) Appl. No.: 19/395,062

(22) Filed: Nov. 20, 2025

Related U.S. Application Data
(60) Provisional application No. 63/723,635, filed on Nov. 22, 2024.
(60) Provisional application No. 63/745,916, filed on Jan. 16, 2025.
(60) Provisional application No. 63/827,476, filed on Jun. 20, 2025.

(51) Int. Cl. G02B 6/42; G02B 6/32; G02B 27/30; H04B 10/40

(52) U.S. Cl. CPC G02B 6/4201; G02B 6/32; G02B 27/30; H04B 10/40

(57) ABSTRACT

A multi-channel optical fiber transmission interface includes multiple optical fibers, an optical fiber array unit, a photonic integrated circuit, a first lens array, and a second lens array. The optical fiber array unit is configured to connect the optical fibers. The optical fiber array unit includes a transceiver end surface. The photonic integrated circuit includes a grating coupler array. The transceiver end surface of the optical fiber array unit faces the grating coupler array. The first lens array is located between the grating coupler and the optical fiber array unit and is configured to connect the transceiver end surface of the optical fiber array unit. The second lens array is located between the grating coupler array and the first lens array. The second lens array is opposite to the first lens array and is configured to adjust the collimation and alignment of the light.

### CROSS-REFERENCE TO RELATED APPLICATION

This application claims priority to U.S. Provisional Application Ser. No. 63/723,635, filed Nov. 22, 2024, U.S. Provisional Application Ser. No. 63/745,916, filed Jan. 16, 2025, U.S. Provisional Application Ser. No. 63/827,476, filed Jun. 20, 2025.

### BACKGROUND

### Field of Invention

The present invention relates to a multi-channel optical fiber transmission interface, and manufacturing method of the multi-channel optical fiber transmission interface.

### Description of Related Art

Due to the rapid development of generative AI technology, processors often need to incorporate multiple graphics processors and AI accelerators to handle the massive computational and data transmission requirements. In traditional methods, signal conversion is performed using optical transceivers, which results in power dissipation as high as 25 pJ/bit.

Co-packaged optics technique integrates optical components and electronic chips. However, how to simultaneously transmitting a large quantity of optical signal while reducing power dissipation remains a challenge for co-packaged technology.

Accordingly, it is still a goal of research and development in this field to provide a transmission device and method that can facilitates optical signal transmission and reduces power dissipation is still one of the directions that urgently need to be studied.

### SUMMARY

One aspect of the disclosure is a multi-channel optical fiber transmission interface.

In one embodiment, multi-channel optical fiber transmission interface includes multiple optical fibers, an optical fiber array unit, a photonic integrated circuit, a first lens array, and a second lens array. The optical fiber array unit is configured to connect the optical fibers. The optical fiber array unit includes a transceiver end surface. The photonic integrated circuit includes a grating coupler array. The transceiver end surface of the optical fiber array unit faces the grating coupler array. The first lens array is located between the grating coupler array and the optical fiber array unit and is configured to connect the transceiver end surface of the optical fiber array unit. The second lens array is located between the grating coupler array and the first lens array. The second lens array is opposite to the first lens array and is configured to adjust the collimation and alignment of the light.

Another aspect of the disclosure is a multi-channel optical fiber transmission interface.

In one embodiment, multi-channel optical fiber transmission interface includes multiple optical fibers, an optical fiber array unit, a photonic integrated circuit, and a lens array. The optical fiber array unit is configured to connect the optical fibers. The photonic integrated circuit includes a grating coupler array. The lens array connects the optical fiber array unit and located above the photonic integrated circuit. The lens array is located between the grating coupler array and the optical fiber array unit, and the lens array is opposite to the grating coupler and configured to couple a light.

Another aspect of the disclosure is a manufacturing method of the multi-channel optical fiber transmission interface.

In one embodiment, the manufacturing method of the multi-channel optical fiber transmission interface includes forming a grating coupler array in a photonic integrated circuit; disposing an optical fiber array unit such that a transceiver end surface of the optical fiber array unit faces the grating coupler array; disposing a first lens array and a second lens array between the grating coupler array and the optical fiber array unit to couple a light, such that the first lens array or the second lens array is pluggable, and the first lens array includes first light adjusting elements, and the second lens array includes second light adjusting elements. When an optical fiber interval of the optical fiber array unit is equal to a coupler interval of the grating coupler array, making the phase centers of the first light adjusting elements respectively aligned to the optical fiber cores of the optical fibers along a vertical direction and the phase centers of the second light adjusting elements respectively aligned to the transceiver centers of the grating coupler array. When the optical fiber interval is not equal to the coupler interval, the phase centers of the first light adjusting elements have a first drift distribution relative to the optical fiber cores along a horizontal direction, a position of the smallest one in the first drift distribution is a first aligning center, and the first drift distribution gradually increase relative to the first aligning center, wherein the phase centers of the second light adjusting elements have a second drift distribution relative to the transceiver centers of the grating coupler array along the horizontal direction, a position of the smallest one in the second drift distribution is a second aligning center, and the second drift distribution gradually increase relative to the second aligning center.

In the aforementioned embodiments, the multi-channel optical fiber transmission interface of the present disclosure can couple the lights from multiple optical fibers to the grating coupler array of the photonic integrated circuit simultaneously through the first lens array and the second lens array, and therefore the data transmission rate can be improved and the power dissipation can be reduced to 1 pJ/bit simultaneously in the co-packaged technique to provide computing and transmission requirements for generative AI technique. Or, coupling the lights to the grating coupler array through a lens array connected with the optical fiber array unit. In addition, the first lens array and the second lens array are pluggable, which can be compatible with different requirements of optical fibers and grating couplers. A distance is maintained between the first lens array and the second lens array, damages to the first lens array and the second lens array caused by gathered dust when the first lens array and the second lens array are being plugged and unplugged repeatedly can be avoided. The light with different incident angles can be focused on the grating coupler array simultaneously as an array through the relative displacement between the first lens array and the second lens array along the horizontal direction. When the optical fiber interval is not equal to the coupler interval, makes the first drift distribution of the phase centers of the first light adjusting elements and the optical fiber cores gradually increase relative to the first aligning center, and makes the second drift distribution of the phase centers of the second light adjusting elements and the transceiver centers of the grating coupler array gradually increase relative to the second aligning center. As such, the optical fiber array unit and the grating coupler array with different specifications can be matched based on scale through the first lens array and the second lens array to adapt the trend of gradually decreasing coupler interval due to the process improvement of the photonic integrated circuit.

### BRIEF DESCRIPTION OF THE DRAWINGS

The invention can be more fully understood by reading the following detailed description of the embodiment, with reference made to the accompanying drawings as follows:

FIG. 1 is a schematic diagram of a multi-channel optical fiber transmission interface according to one embodiment of the present disclosure.

FIG. 2A is a cross-sectional view taken along line 2A-2A in FIG. 1.

FIG. 2B is a cross-sectional view taken along line 2B-2B in FIG. 1.

FIG. 3 is a schematic diagram of an optical path in a lens region of the multi-channel optical fiber transmission interface in FIG. 1.

FIG. 4A is a partial enlarged view of a first lens array and an optical fiber array unit according to one embodiment of the present disclosure.

FIG. 4B is a partial enlarged view of a second lens array and a photonic integrated circuit according to one embodiment of the present disclosure.

FIG. 5A is a partial enlarged view of a first lens array and an optical fiber array unit according to one embodiment of the present disclosure.

FIG. 5B is a partial enlarged view of a second lens array and a photonic integrated circuit according to one embodiment of the present disclosure.

FIG. 6 is a schematic diagram of an optical path of a multi-channel optical fiber transmission interface according to one embodiment of the present disclosure.

FIG. 7 is a schematic diagram of an optical path of a multi-channel optical fiber transmission interface according to one embodiment of the present disclosure.

FIG. 8 is a schematic diagram of a multi-channel optical fiber transmission interface according to one embodiment of the present disclosure.

FIG. 9 is a schematic diagram of an optical path in a lens region of the multi-channel optical fiber transmission interface in FIG. 8.

FIG. 10 is a partial enlarged view of a second lens array and a photonic integrated circuit according to one embodiment of the present disclosure.

FIG. 11 is a schematic diagram of a multi-channel optical fiber transmission interface according to one embodiment of the present disclosure.

FIG. 12 is a schematic diagram of an optical path in a lens region of the multi-channel optical fiber transmission interface in FIG. 11.

FIG. 13 is a schematic diagram of a multi-channel optical fiber transmission interface according to one embodiment of the present disclosure.

FIG. 14 is a schematic diagram of a multi-channel optical fiber transmission interface according to one embodiment of the present disclosure.

FIG. 15A is a cross-sectional view taken along line 15A-15A in FIG. 14.

FIG. 15B is a cross-sectional view taken along line 15B-15B in FIG. 14.

FIG. 15C is a cross-sectional view taken along line 15C-15C in FIG. 14.

FIG. 16 is a schematic diagram of an optical path in a lens region of the multi-channel optical fiber transmission interface in FIG. 14.

FIG. 17 is an enlarged view of the optical fiber array unit and the first lens array in FIG. 16.

FIG. 18 is an enlarged view of the second lens array and the photonic integrated circuit in FIG. 16.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

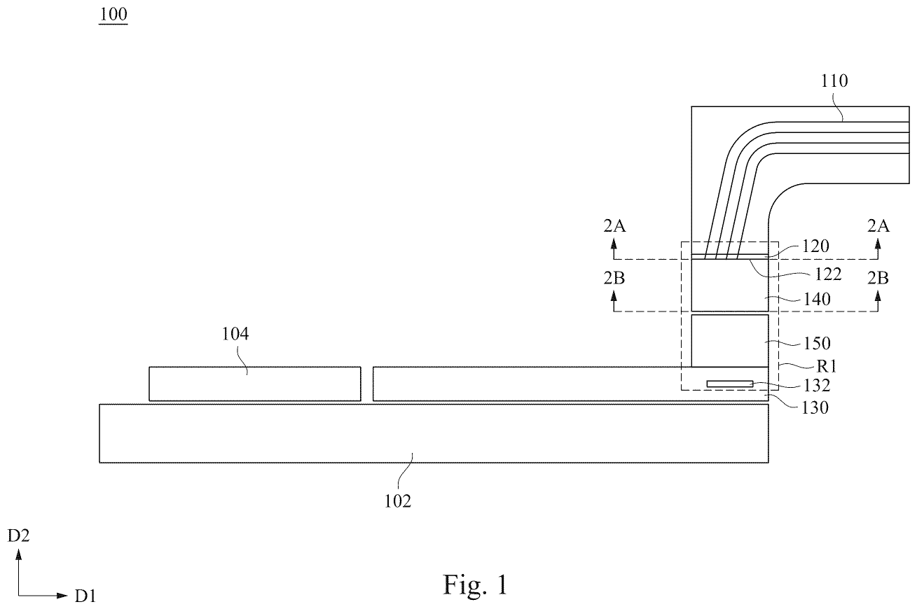

FIG. 1 is a schematic diagram of a multi-channel optical fiber transmission interface 100 according to one embodiment of the present disclosure. The multi-channel optical fiber transmission interface 100 includes multiple optical fibers 110, an optical fiber array unit 120, a photonic integrated circuit (PIC) 130, a first lens array 140, and a second lens array 150. The optical fiber array unit 120 is configured to connect the optical fibers 110. The photonic integrated circuit 130 includes a grating coupler array 132. The first lens array 140 is located between the grating coupler array 132 and the optical fiber array unit 120 and is configured to connect the transceiver end surface 122 of the optical fiber array unit 120. The second lens array 150 is located between the grating coupler array 132 and the first lens array 140. The second lens array 150 is opposite to the first lens array 140 and is configured to adjust the collimation and alignment of the light. In other words, the transceiver end surface 122 faces the grating coupler array 132. In addition, the grating coupler array 132 can be configured to transceive a light with smaller mode field width, such as a mode field width smaller than 15 μm, after further adjusting the collimation and alignment of the light through the combination of the first lens array 140 and the second lens array 150. In the present embodiment, the optical fiber array unit 120, the first lens array 140, and the second lens array 150 are stacked along a vertical direction D2.

The photonic integrated circuit 130 is disposed on the substrate 102, and is electrically connected with an application-specific integrated circuit (ASCI) 104. In the present embodiment, the optical fibers 110 are bended, but the present disclosure is not limited thereto.

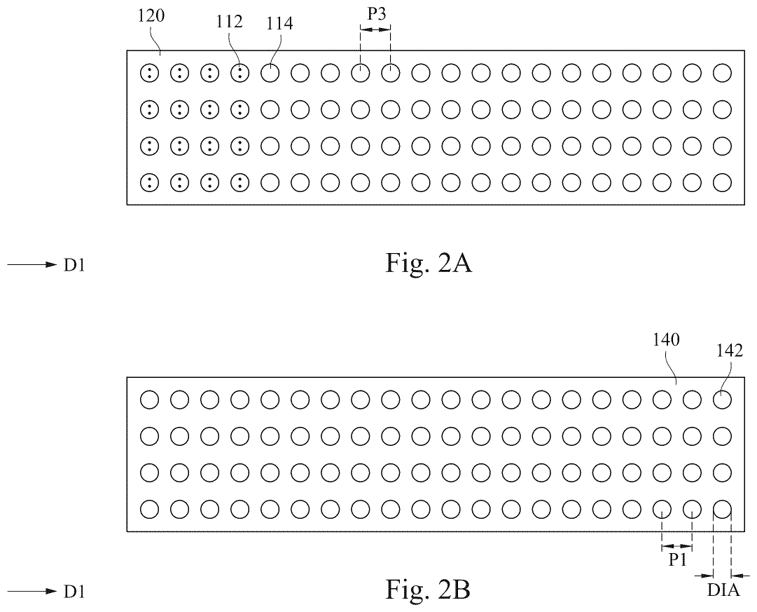

FIG. 2A is a cross-sectional view taken along line 2A-2A in FIG. 1. The optical fibers 110 can be one of the polarization-maintaining fiber 112 and a single mode fiber 114, or a combination thereof. In the present embodiment, the optical fibers 110 are combinations of the polarization-maintaining fibers 112 and the single mode fibers 114, but the present disclosure is not limited thereto. The polarization-maintaining fiber 112 can maintain polarization of the light, and the single mode fiber 114 provides input and output of the light signal. In the present embodiment, 80 optical fibers 110 are arranged as a 4×20 array, but the present disclosure is not limited thereto.

FIG. 2B is a cross-sectional view taken along line 2B-2B in FIG. 1. The first lens array 140 includes multiple first light adjusting elements 142, and the first light adjusting elements 142 are arranged as a 4×20 array corresponding to the optical fiber array unit 120.

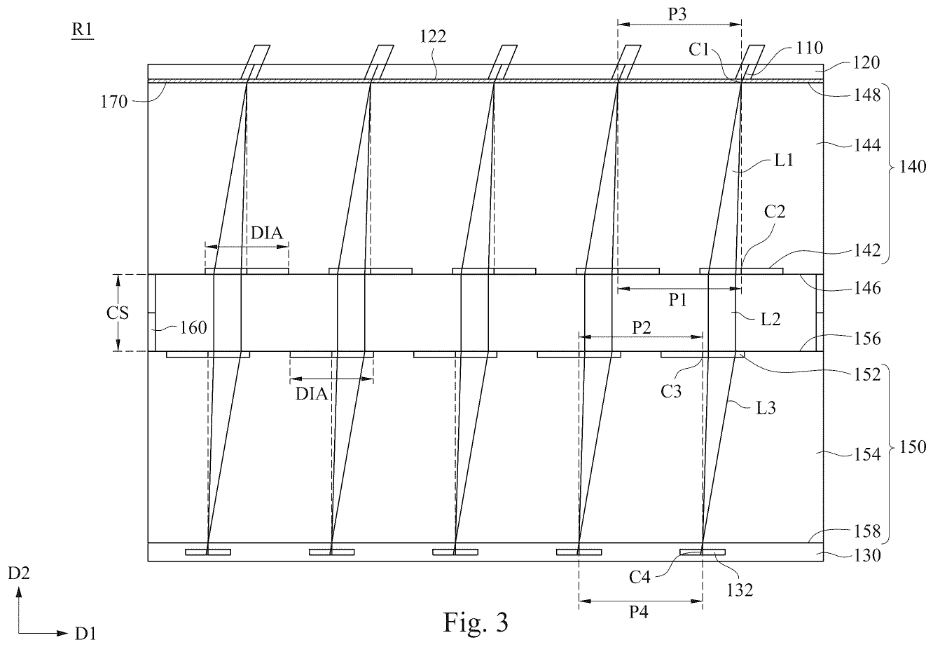

FIG. 3 is a schematic diagram of an optical path in a lens region R1 of the multi-channel optical fiber transmission interface 100 in FIG. 1. The second lens array 150 includes multiple second light adjusting elements 152, which are arranged as a 4×20 array. The second lens array 150 has a similar cross-sectional view as the first lens array 140 (see FIG. 2B). In the present embodiment, a relative position of the first light adjusting elements 142 and the second light adjusting elements 152 along the horizontal direction D1 is misaligned. In other embodiment, the relative position of the first light adjusting elements 142 and the second light adjusting elements 152 along the horizontal direction D1 can be aligned, which will be described later.

The first lens array 140 includes a substrate 144, and the first light adjusting elements 142 is disposed at a side of the first lens array 140 directly faces the second lens array 150. The first lens array 140 includes a first surface 146 facing the second lens array 150, and the first surface 146 is substantially equivalent to a top surface of the first light adjusting elements 142. The second lens array 150 includes a substrate 154, and the second light adjusting elements 152 is disposed at a side of the second lens array 150 directly faces the first lens array 140. The second lens array 150 includes a second surface 156 facing the first lens array 140, and the second surface 156 is substantially equivalent to a top surface of the second light adjusting elements 152. In other words, the normal direction of the transceiver end surface 122 of the optical fiber array unit 120, the first surface 146 of the first lens array 140, and the second surface 156 of the second lens array 150 of the present embodiment is substantially parallel with the vertical direction D2. Therefore, the definition of the second lens array 150 is opposite to the first lens array 140 is that the first light adjusting elements 142 faces the second light adjusting elements 152 and are one-to-one matched. The shapes of the first light adjusting elements 142 and the second light adjusting elements 152 can be circular or square, but the present disclosure is not limited thereto.

The material of the substrate 144 and the substrate 154 can be silicon substrate, glass, optical resin, or optical plastic, etc., but the present disclosure is not limited thereto. The first light adjusting elements 142 and the second light adjusting elements 152 can be meta-lens, micro-lens, diffractive element or plasmonic element. The meta-lens is formed by semiconductor process. The micro-lens can be formed by embossing process. The diffractive element and the plasmonic element can be formed by laser process, but the present disclosure is not limited thereto.

The first surface 146 of the first lens array 140 and the second surface 156 of the second lens array 150 have a distance CS therebetween, and the distance CS is in a range greater than 0 μm and smaller than 1000 μm. This distance CS is collimation space. That is, the light passed through the first light adjusting elements 142 satisfies Gaussian light transmission before entering the second light adjusting elements 152, and the collimation light does not diverge herein, but the present disclosure is not limited thereto.

Reference is made to FIG. 1 and FIG. 3. An example of a light transmitted from the optical fibers 110 to the grating coupler array 132 is demonstrated herein. An incident light L1 diverges when passes through the substrate 144 of the first lens array 140, and subsequently converges as a collimation light L2 by the first light adjusting elements 142. In the present embodiment, the traveling direction of the collimation light L2 is perpendicular to the first surface 146 and the second surface 156, but the present disclosure is not limited thereto. The collimation light L2 converges as a receiving light L3 after entering the second light adjusting elements 152 of second lens array 150, and subsequently focuses on the grating coupler array 132.

Reference is made to FIG. 1. The multi-channel optical fiber transmission interface 100 of the present disclosure can couple the lights from multiple optical fibers 110 to the grating coupler array 132 of the photonic integrated circuit 130 simultaneously through the first lens array 140 and the second lens array 150. The first lens array 140 and the second lens array 150 are pluggable, for example, by engaging with each other through a coupling structure 160. Since a distance CS is maintained between the first surface 146 of the first lens array 140 and the second surface 156 of the second lens array 150, damages to the first light adjusting elements 142 and the second light adjusting elements 152 caused by gathered dust directly contacting the first lens array 140 and the second lens array 150 when the first lens array 140 and the second lens array 150 are being plugged and unplugged repeatedly can be avoided.

The multi-channel optical fiber transmission interface 100 of the present disclosure can couple the lights as an array to the photonic integrated circuit 130, and therefore the data transmission rate can be improved and the power dissipation can be reduced to 1 pJ/bit simultaneously in the co-packaged technique to provide computing and transmission requirements for generative AI technique. Since the first lens array 140 is connected to the optical fiber array unit 120 and the second lens array 150 is connected to the photonic integrated circuit 130, the pluggable first lens array 140 and second lens array 150 can be compatible with different requirements of optical fibers and grating couplers.

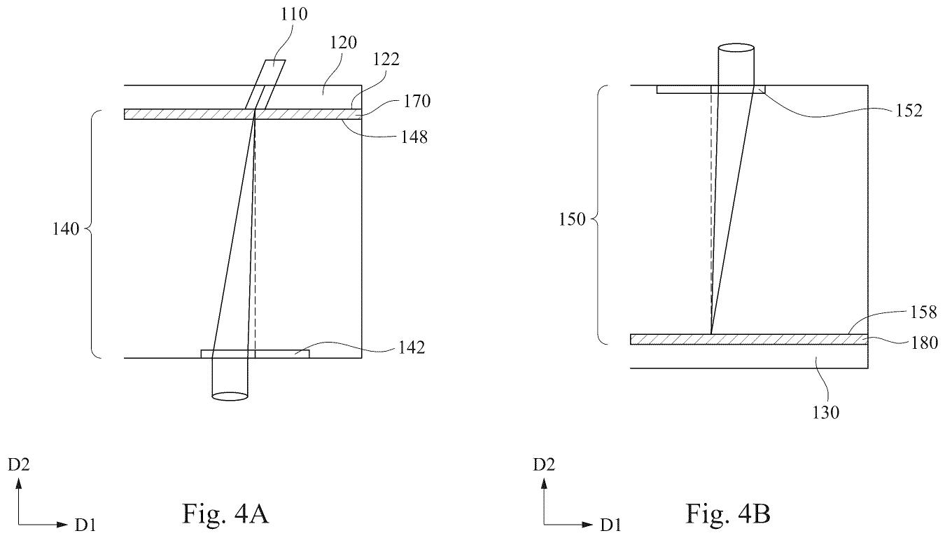

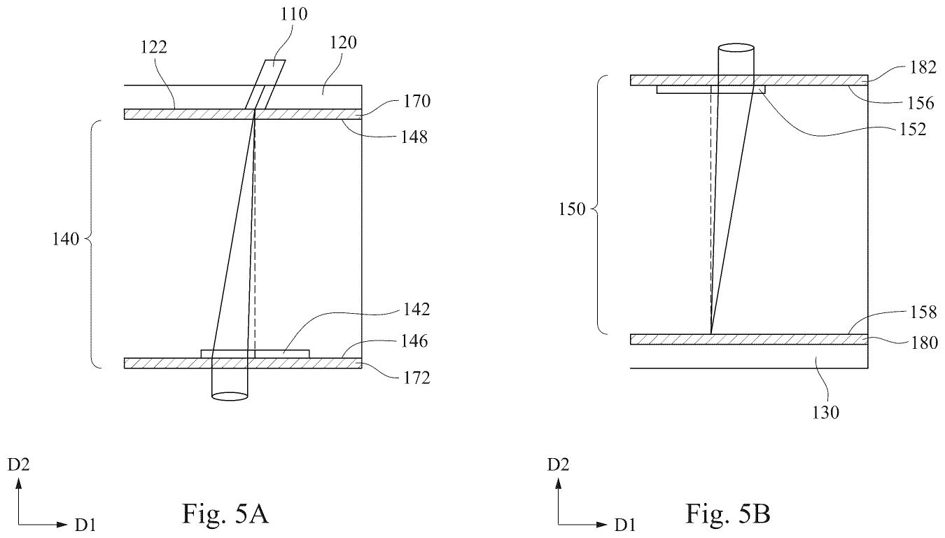

FIG. 4A is a partial enlarged view of a first lens array 140 and an optical fiber array unit 120 according to one embodiment of the present disclosure. FIG. 4B is a partial enlarged view of a second lens array 150 and a photonic integrated circuit 130 according to one embodiment of the present disclosure. In the present embodiment, the first light adjusting elements 142 and the second light adjusting elements 152 are meta-lens. The overall structure of a meta-lens observed in a macroscopic state is close to a plane, and many nanostructures are contained therein. The shapes of the nanostructures includes pillar, cone, cone with a flat top, hole, or any combination thereof, but the present disclosure is not limited thereto. The height of the nanostructures is in a range from 50 nm to 2000 nm. The material of the nanostructures includes silicon, glass, silicon nitride, or oxides, etc., but the present disclosure is not limited thereto. The profile shape of the nanostructures in a plan view includes circular, square, rectangular, cross-shaped, donut-shaped, and elliptical or a combination thereof. The feature size of the nanostructures is in a range from 10 nm to 750 nm, and the nanostructures can contain a combination of different feature sizes. A profile shape of the meta-lens includes the patterns arranged by the nanostructures, such as concentric ring patterns or hexagonal patterns.

The first lens array 140 includes a third surface 148 facing the optical fiber array unit 120 and a first optical coating layer 170 located on the third surface 148. The first lens array 140 is adhered to the optical fiber array unit 120 through the first optical coating layer 170. The second lens array 150 includes a fourth surface 158 facing the photonic integrated circuit 130 and a second optical coating layer 180 located on the fourth surface 158, the first optical coating layer 170 and the second optical coating layer 180 include one of an anti-reflection layer and a refractive index matching layer or is a mixed coating layer. The thickness of the first optical coating layer 170 and the second optical coating layer 180 is smaller than 150 μm to avoid displacement caused by heat deformation in manufacturing process.

The anti-reflection layer can reduce the light reflectivity when the light passes through the interface between the optical fiber array unit 120 and the first lens array 140, and reduce the light reflectivity when the light passes through the interface between the second lens array 150 and the photonic integrated circuit 130. The refractive index matching layer can eliminate refraction caused by refractive index difference between different mediums. With aforementioned structure, optical signal dissipation is prevented and the optical transmission rate is improved. In some embodiment, when the mediums presented at two sides of the interface are the same, the refractive index matching layer can be omitted.

In other embodiments, the diffractive element and the plasmonic element are used as the first light adjusting elements 142 and the second light adjusting elements 152, the first optical coating layer 170 and the second optical coating layer 180 can be disposed thereon as described above. The diffractive element includes Fresnel lens and has grating groove structures with variable density. Feature size of such structure is in a range from 10 nm to 750 nm. The material includes silicon, glass, optical resins or optical plastics, etc., but the present disclosure is not limited thereto. A profile shape includes patterns arranged by the grating groove structures, such as concentric ring patterns or hexagonal patterns. The plasmonic element includes metal slit structures. Feature size of such structure is in a range from 10 nm to 750 nm. The material includes golden, silver, aluminum, or copper, etc., but the present disclosure is not limited thereto. A profile shape includes patterns arranged by the slit structures, such as concentric ring patterns or hexagonal patterns.

FIG. 5A is a partial enlarged view of a first lens array 140 and an optical fiber array unit 120 according to one embodiment of the present disclosure. FIG. 5B is a partial enlarged view of a second lens array 150 and a photonic integrated circuit 130 according to one embodiment of the present disclosure. In the present embodiment, the first light adjusting elements 142 and the second light adjusting elements 152 are micro-lens. Due to smoother surface of the micro-lens, the first lens array 140 further includes a third optical coating layer 172 located on the first surface 146, and the second lens array 150 further includes a fourth optical coating layer 182 located on the second surface 156. The third optical coating layer 172 and the fourth optical coating layer 182 include one of an anti-reflection layer and a refractive index matching layer or is a mixed coating layer. In other words, in the present embodiment, the top surface of the first lens array 140 facing the second lens array 150 is the third optical coating layer 172, and the top surface of the second lens array 150 facing the first lens array 140 is the fourth optical coating layer 182. The distance CS is the distance between the third optical coating layer 172 and the fourth optical coating layer 182.

Reference is made to FIG. 3. The first light adjusting elements 142 and the second light adjusting elements 152 have a width DIA, and the width DIA is in a range from 50 μm to 250 μm. The first light adjusting elements 142 have first intervals P1, the second light adjusting elements 152 have second intervals P2, and the first intervals P1 and the second intervals P2 are in a range from 50 μm to 250 μm.

The distances between the optical cores C1 of the optical fibers 110 are defined as optical fiber intervals P3, the distances between the transceiver centers C4 of the grating coupler array 132 are defined as coupler intervals P4. The optical fiber intervals P3 and the coupler intervals P4 are in a range from 50 μm to 250 μm.

When the optical fiber interval P3 is equal to the coupler interval P4, the phase centers C2 of the first light adjusting elements 142 are respectively aligned with optical fiber cores C1 of the optical fibers 110 along the vertical direction D2 (illustrated by dash line along the vertical direction D2), and the phase centers C3 of the second light adjusting elements 152 are respectively aligned with the transceiver centers C4 of the grating couplers array 132 along the vertical direction D2 (illustrated by dash line along the vertical direction D2). The first interval P1 is equal to the second interval P2.

In the present embodiment, the optical fibers 110 emits inclined incident lights from the right-hand side, and therefore the incident lights L1 and a normal direction of the third surface 148 have an inclined angle, such as 8 degrees. The inclined incident lights can reduce reflectivity ratio of the incident lights L1 from the optical fibers 110 to reduce optical signal dissipation.

The incident lights L1 pass through a left part of the first light adjusting elements 142 and converge as the collimation lights L2. In the present embodiment, adapting to the design of the grating coupler array 132, the transmission light angle of the receiving lights L3 to the transceiver centers C4 of the grating couplers array 132 is fixed. The collimation lights L2 pass through a right part of the second light adjusting elements 152, and therefore converge as the receiving lights L3 and focus on the grating coupler array 132. That is, the misalignment between the first lens array 140 and the second lens array 150 along the horizontal direction D1 can make the left part of the first light adjusting elements 142 align with the right part of the second light adjusting elements 152. The lights from the inclined optical fibers 110 can be focused on the grating coupler array 132 simultaneously as an array through the relative displacement between the first lens array 140 and the second lens array 150 along the horizontal direction D1.

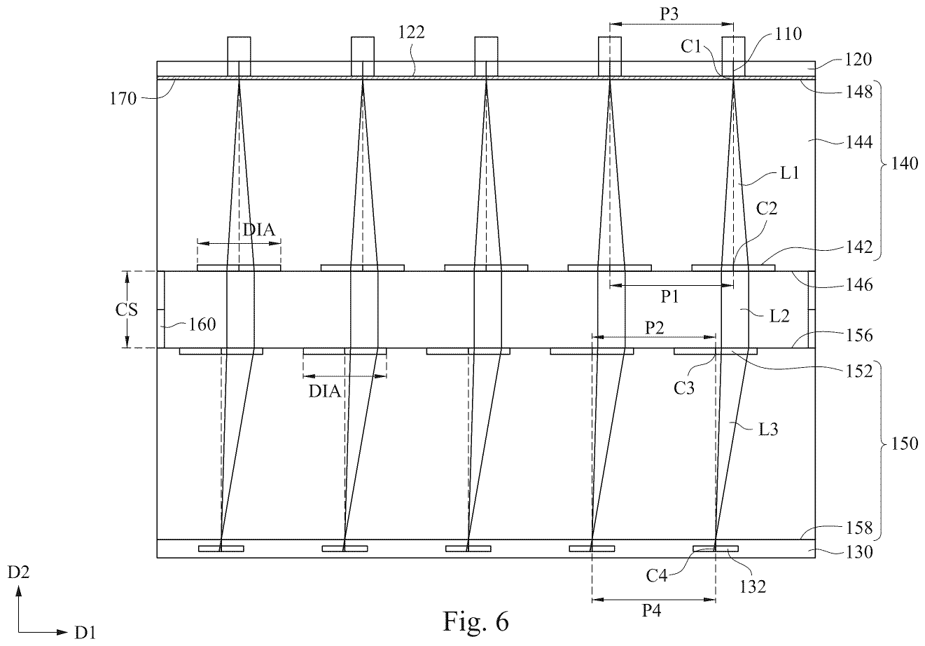

FIG. 6 is a schematic diagram of a multi-channel optical fiber transmission interface according to one embodiment of the present disclosure. FIG. 6 is an enlarged view of the same lens region shown in FIG. 3. In the present embodiment, the optical fibers 110 emits incident lights vertically, and therefore the incident lights L1 are parallel with the normal direction of the third surface 148. The incident lights L1 symmetrically pass through central parts of the first light adjusting elements 142, and pass the phase centers C2 to converge as the collimation lights L2. The collimation lights L2 pass through the right part of the second light adjusting elements 152, and therefore converge as the receiving lights L3 and focus on the grating coupler array 132. That is, the misalignment between the first lens array 140 and the second lens array 150 along the horizontal direction D1 can make the phase centers C2 of the first light adjusting elements 142 align with the right part of the second light adjusting elements 152. The lights from the vertical optical fibers 110 can be focused on the grating coupler array 132 simultaneously as an array through the relative displacement between the first lens array 140 and the second lens array 150 along the horizontal direction D1.

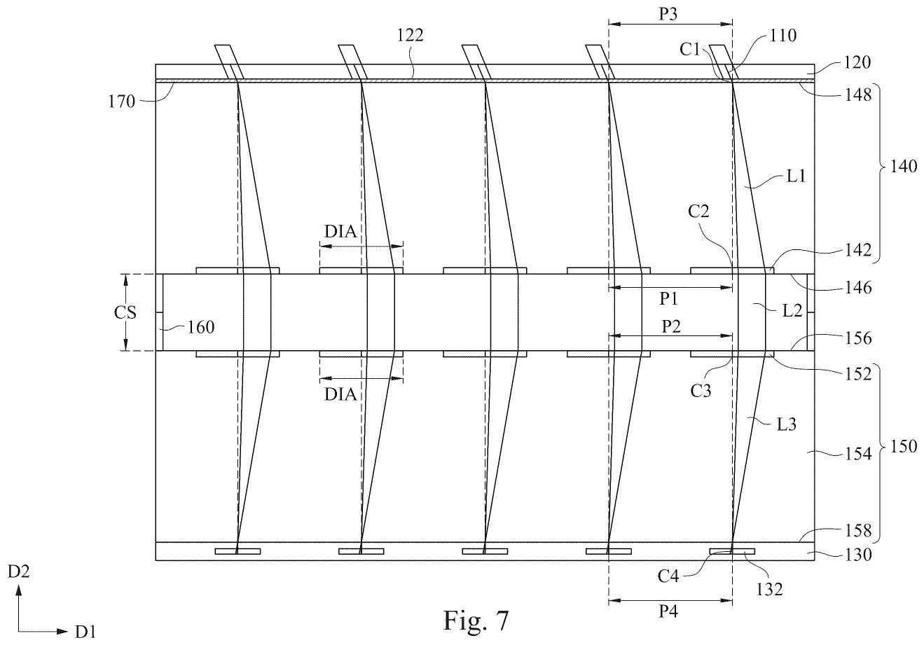

FIG. 7 is a schematic diagram of a multi-channel optical fiber transmission interface according to one embodiment of the present disclosure. FIG. 7 is an enlarged view of the same lens region shown in FIG. 3. In the present embodiment, the optical fibers 110 emit inclined incident lights from the left-hand side, and therefore the incident lights L1 and a normal direction of the third surface 148 have an inclined angle, such as 8 degrees. The incident lights L1 pass through a right part of the first light adjusting elements 142 and converge as the collimation lights L2. The collimation lights L2 pass through a right part of the second light adjusting elements 152, and therefore converge as the receiving lights L3 and focus on the grating coupler array 132. That is, the misalignment between the first lens array 140 and the second lens array 150 along the horizontal direction D1 can make the right part of the first light adjusting elements 142 align with the right part of the second light adjusting elements 152. The light from the inclined optical fibers 110 can be focused on the grating coupler array 132 simultaneously as an array through the relative displacement between the first lens array 140 and the second lens array 150 along the horizontal direction D1.

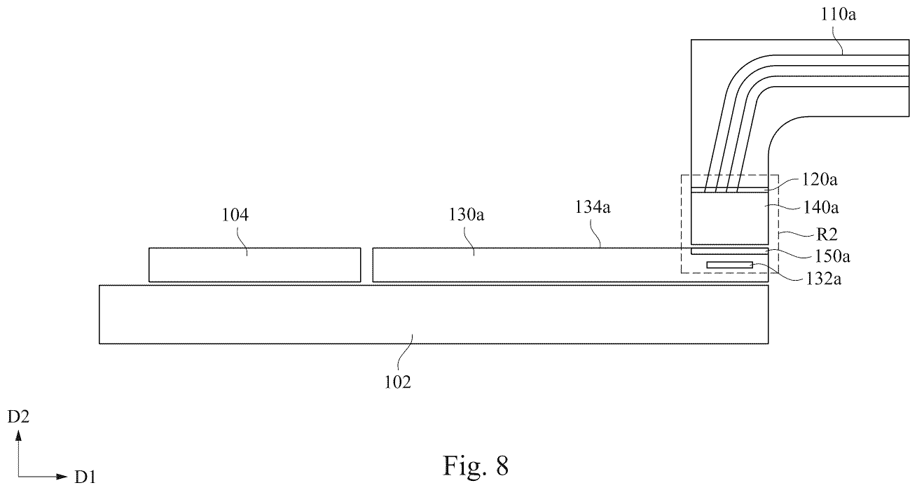

FIG. 8 is a schematic diagram of a multi-channel optical fiber transmission interface 100a according to one embodiment of the present disclosure. The multi-channel optical fiber transmission interface 100a is similar to the multi-channel optical fiber transmission interface 100 in FIG. 1, and the difference is that the second lens array 150a of the multi-channel optical fiber transmission interface 100a is embedded and integrated in the photonic integrated circuit 130a. The second lens array 150a is located above the grating coupler array 132a, and is adjacent to the top surface 134a of the photonic integrated circuit 130a facing the first lens array 140a. A relative width relation between the grating coupler array 132a and the second lens array 150a is not restricted. In the present embodiment, a step of layering the second light adjusting elements 152a is added to the manufacturing process of the photonic integrated circuit 130a so as to integrate the processes of the second light adjusting elements 152a with the grating coupler array 132a. Since the second lens array 150a is embedded in the photonic integrated circuit 130a, there is no need to dispose an optical coating layer on the surface of the second lens array 150a away from the first lens array 140a.

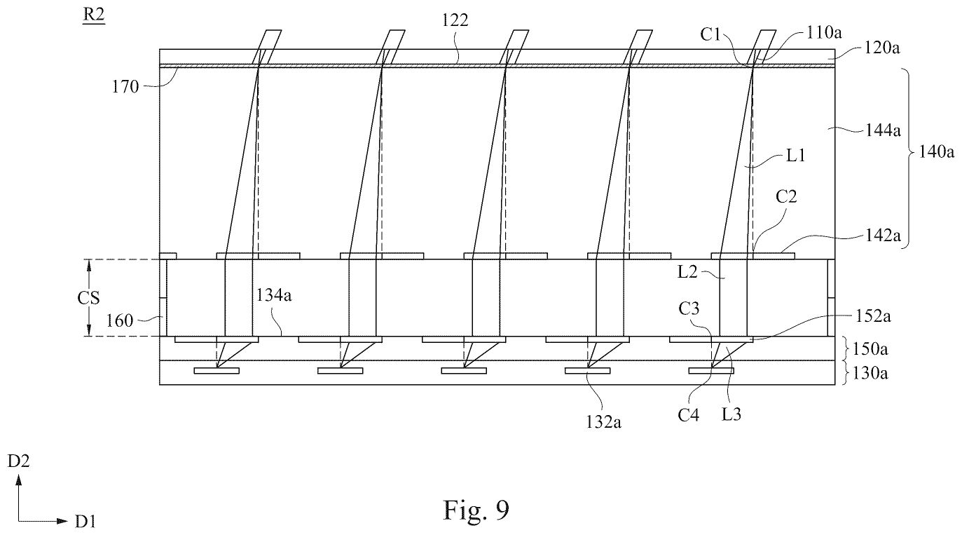

FIG. 9 is a schematic diagram of an optical path in a lens region R2 of the multi-channel optical fiber transmission interface 100a in FIG. 8. An example of the optical fibers 110a emitting inclined incident lights from right-hand side is demonstrated herein. The incident lights L1 pass through a left part of the first light adjusting elements 142a and converge as the collimation lights L2. The collimation lights L2 pass through a right part of the second light adjusting elements 152a, and therefore converge as the receiving lights L3 and focus on the grating coupler array 132a. That is, the misalignment between the first lens array 140a and the second lens array 150a along the horizontal direction D1 can make the left part of the first light adjusting elements 142a align with the right part of the second light adjusting elements 152a. The lights from the inclined optical fibers 110a can be focused on the grating coupler array 132a simultaneously as an array through the relative displacement between the first lens array 140a and the second lens array 150a along the horizontal direction D1. The multi-channel optical fiber transmission interface 100a and the multi-channel optical fiber transmission interface 100 have the same advantages, and the description is not repeated hereinafter. The relative configuration between the optical fibers 110, the first lens array 140, and the second lens array 150 shown in FIG. 6 and FIG. 7 can also be applied in the embodiment of FIG. 9, and the description is not repeated hereinafter.

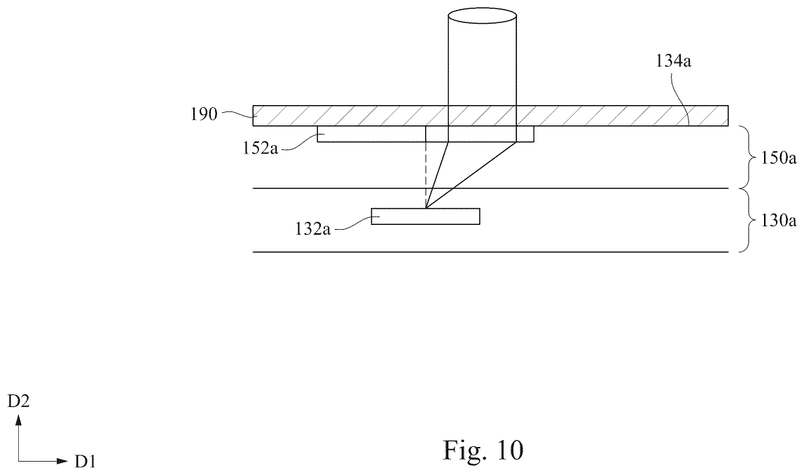

FIG. 10 is a partial enlarged view of a second lens array 150a and a photonic integrated circuit 130a according to one embodiment of the present disclosure. In the present embodiment, the manufacturing step of layering the second light adjusting elements 152a can further includes disposing a fifth optical coating layer 190 close to the top surface 134a of the photonic integrated circuit 130a. The fifth optical coating layer 190 includes one of an anti-reflection layer and a refractive index matching layer or is a mixed coating layer. The technique advantages of the fifth optical coating layer 190 are substantially the same as those of the fourth optical coating layer 182 in FIG. 5B, and the description is not repeated hereinafter.

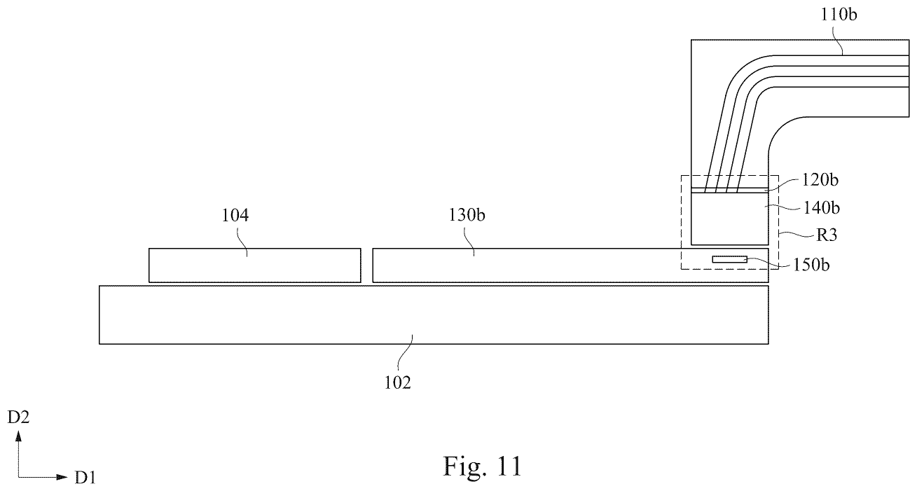

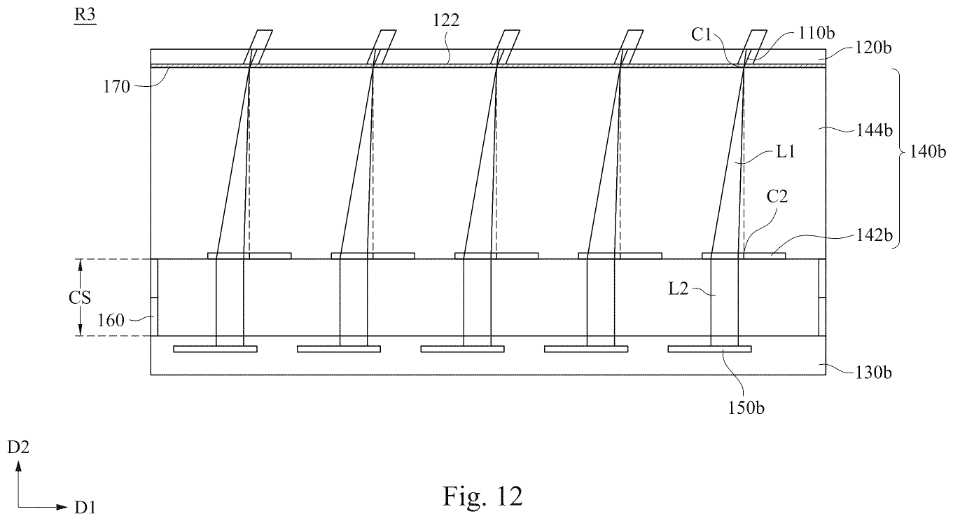

FIG. 11 is a schematic diagram of a multi-channel optical fiber transmission interface 100b according to one embodiment of the present disclosure. FIG. 12 is a schematic diagram of an optical path in a lens region R3 of the multi-channel optical fiber transmission interface 100b in FIG. 11. The multi-channel optical fiber transmission interface 100b is similar to the multi-channel optical fiber transmission interface 100a in FIG. 8, and the difference is that the grating coupler array 150b of the multi-channel optical fiber transmission interface 100b includes transceiver ports having large mode field diameter used to replace the functions of the aforementioned grating coupler array 132a and second lens array 150a, and the grating coupler array 150b is located in the photonic integrated circuit 130b and is opposite to the lens array to couple the light.

The transceiver ports having large mode field diameter of the grating coupler array 150b is configured to transceive the light having large mode field diameter. For example, the mode width of the light is in a range from 15 μm to 100 μm. The design of the grating coupler array 150b has beam expansion effect, such that the light emitted have a light spot matching the first lens array 140b. The material of the grating coupler array 150b includes silicon, silicon oxide, or silicon nitride. The structure of the grating coupler array 150b can be fully etched or shallow etched.

An example of the optical fibers 110b emitting inclined incident lights from right-hand side is demonstrated herein. The incident lights L1 pass through a left part of the first light adjusting elements 142b and converge as the collimation lights L2. The collimation lights L2 converge and focus on the grating coupler array 150b as an array. The grating coupler array 150b and the first light adjusting elements 142b are one-to-one matched, and the relative position can be adjusted based on the pattern design of the grating. In other words, it is available as long as the light from the optical fibers 110b can be focused on the grating coupler array 150b through the relative displacement between the first lens array 140b and the grating coupler array 150b. The multi-channel optical fiber transmission interface 100b and the multi-channel optical fiber transmission interface 100 in FIG. 1 have the same advantages, and the description is not repeated hereinafter.

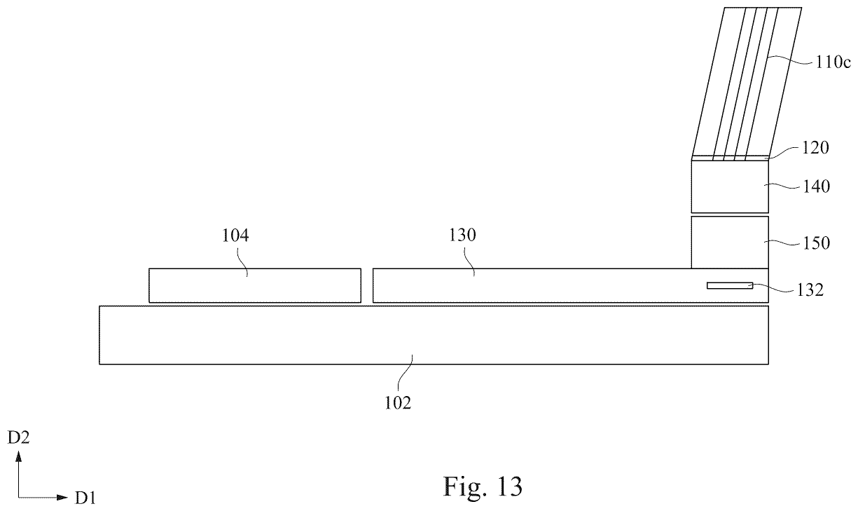

FIG. 13 is a schematic diagram of a multi-channel optical fiber transmission interface 100c according to one embodiment of the present disclosure. The multi-channel optical fiber transmission interface 100c is substantially the same as the multi-channel optical fiber transmission interface 100 in FIG. 1, and the difference is that the optical fibers 110c of the multi-channel optical fiber transmission interface 100c is straight type. The design of the optical fibers 110c can also be applied to the multi-channel optical fiber transmission interfaces in FIG. 1, FIG. 8, and FIG. 11. The multi-channel optical fiber transmission interface 100c and the multi-channel optical fiber transmission interface 100 in FIG. 1 have the same advantages, and the description is not repeated hereinafter.

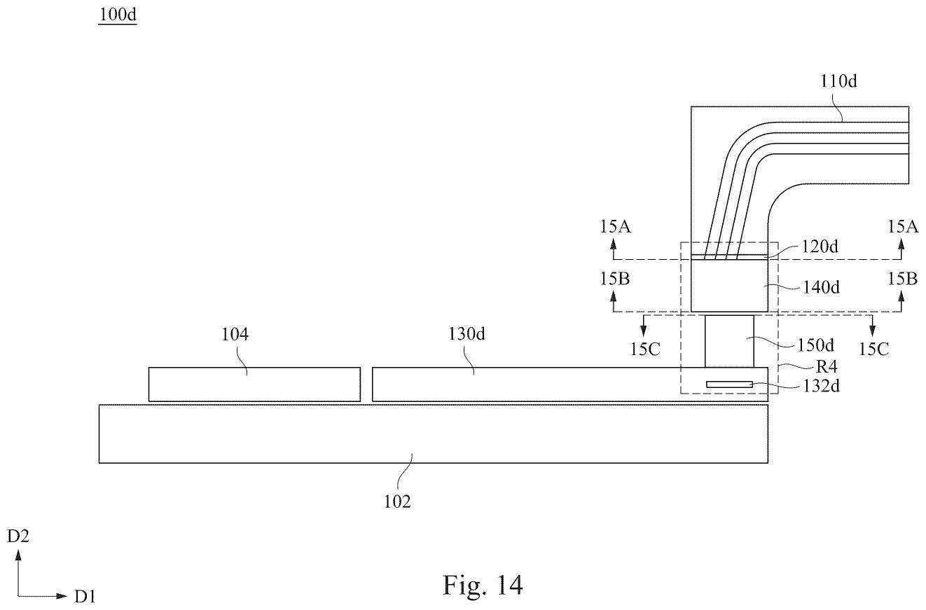

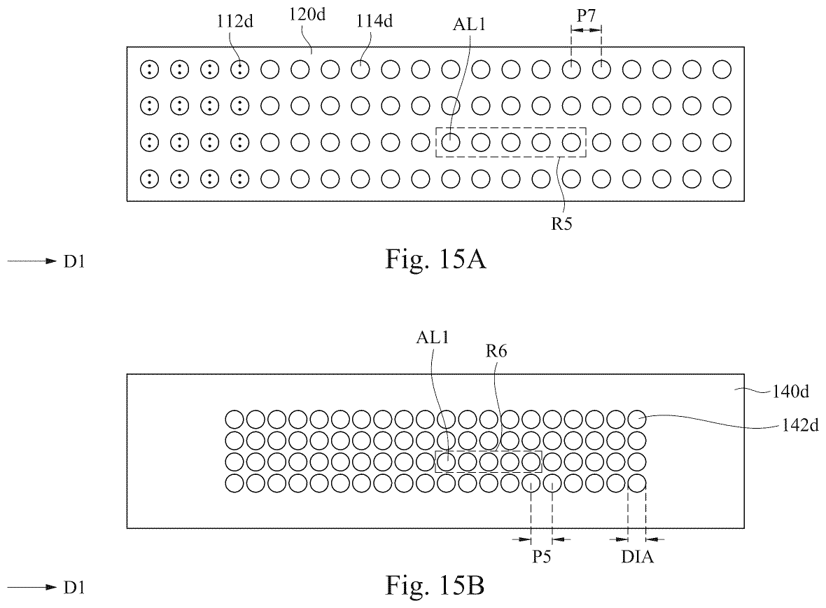

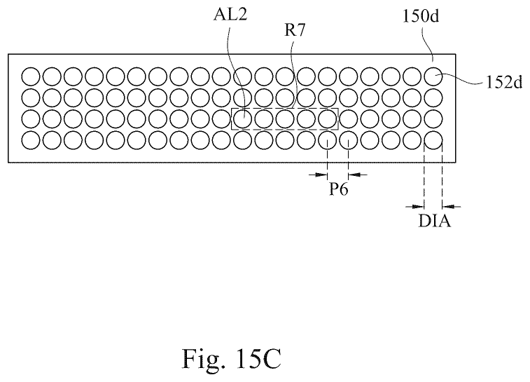

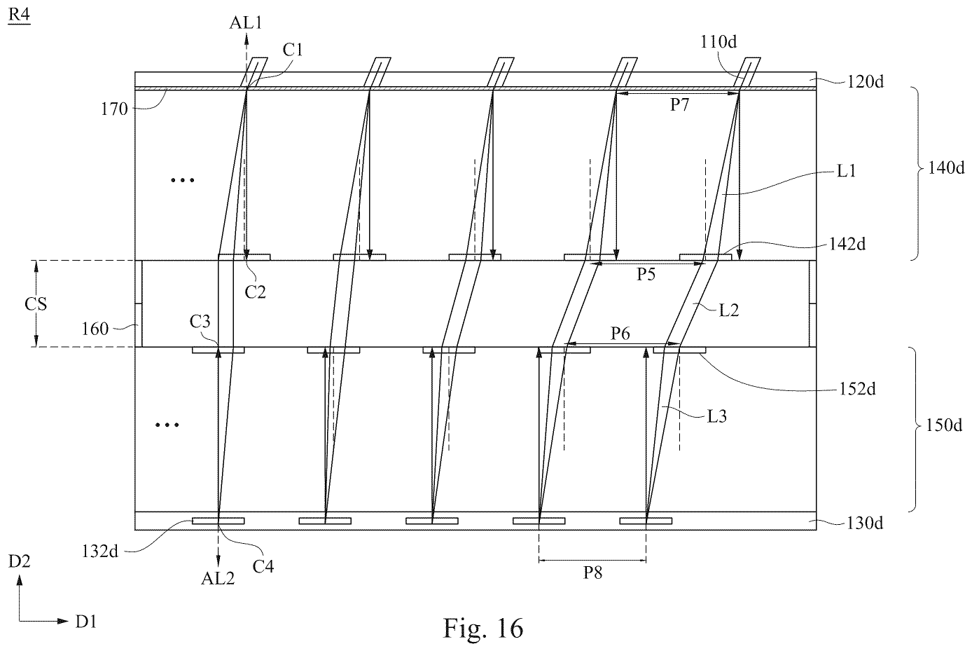

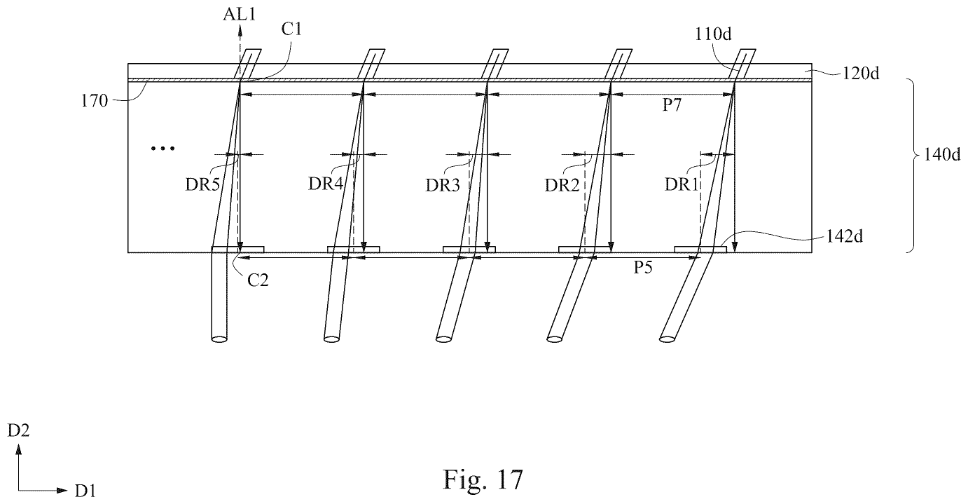

FIG. 14 is a schematic diagram of a multi-channel optical fiber transmission interface 100d according to one embodiment of the present disclosure. FIG. 15A is a cross-sectional view taken along line 15A-15A in FIG. 14. FIG. 15B is a cross-sectional view taken along line 15B-15B in FIG. 14. FIG. 15C is a cross-sectional view taken along line 15C-15C in FIG. 14. The multi-channel optical fiber transmission interface 100d is similar to the multi-channel optical fiber transmission interface 100 in FIG. 1, and the difference is that the optical fiber intervals P7 of the optical fiber array unit 120d and the coupler intervals P8 of the grating coupler array 132d (see FIG. 16) are different. In addition, the size of the second lens array 150d is smaller than the size of the first lens array 140d.

In the present embodiment, the optical fiber array unit 120d shown in FIG. 15A is the same as the optical fiber array unit 120 shown in FIG. 2A. As shown in FIG. 15B and FIG. 15C, the width DIA of the first light adjusting elements 142d and the second light adjusting elements 152d is in the same range as described in FIG. 1. The first interval P5 of the first lens array 140d is smaller than the first interval P1 of the first lens array 140 in FIG. 3. As shown in FIG. 15C, the second interval P6 of the second lens array 150d is smaller than the second interval P2 of the second lens array 150 in FIG. 3. In other words, the first lens array 140d and the second lens array 150d are more compact than the optical fiber array unit 120d.

FIG. 16 is a schematic diagram of an optical path in a lens region R4 of the multi-channel optical fiber transmission interface 100d in FIG. 14. An example of the optical fiber interval P7 greater than the coupler interval P8 is demonstrated as an example. The optical fiber interval P7 is greater than the first interval P5, and the second interval P6 is greater than the coupler interval P8. In the present embodiment, the first interval P5 is equal to the second interval P6, but the present disclosure is not limited thereto. In other embodiments, the first interval P5 is greater than the second interval P6.

The first interval P5, the second interval P6, the optical fiber interval P7, and the coupler interval P8 are in a range from 50 μm to 250 μm. For example, the optical fiber interval P7 is 150 μm, the first interval P5 and the second interval P6 are 140 μm, and the coupler interval P8 is 125 μm. In other words, the optical fiber array unit 120d and the grating coupler array 132d with different specifications can be matched based on scale through the first lens array 140d and the second lens array 150d to adapt the trend of gradually decreasing coupler interval due to the process improvement of the photonic integrated circuit 130.

FIG. 17 is an enlarged view of the optical fiber array unit 120d and the first lens array 140d in FIG. 16. Reference is made to FIG. 15A and FIG. 15B. The lens region R5 of the optical fiber array unit 120d corresponds to the lens region R6 of the first lens array 140d. Reference is made to FIG. 15A, FIG. 15B, and FIG. 17. In general, positions closest to the array center of the optical fiber array unit 120d and the first lens array 140d are aligned or are closest. The phase center C2 and the optical fiber core C1 at the most left side in the lens region R6 have a smallest drift DR5, and the positions herein is defined as a first aligning center AL1.

As the distances relative to the first aligning center AL1 are larger, the drifts between the phase centers C2 and the optical fiber cores C1 are larger. For example, the phase center C2 and the optical fiber core C1 at the most right side in FIG. 17 have a larger drift DR1. Similarly, the phase center C2 and the optical fiber core C1 outside the lens region R6 of the first lens array 140d have even greater drift (not shown). Accordingly, the drifts of the phase centers C2 of the first light adjusting elements 142d and the optical fiber cores C1 along the horizontal direction D1 form a first drift distribution, which gradually increase relative to the first aligning center AL1 (DR5<DR4<DR3<DR2<DR1).

Based on the design of the first drift distribution, the lights passed through the optical fiber array unit 120d can be drawn close towards the first aligning center AL1. Reference is made to FIG. 16. The traveling direction of the collimation lights L2 after emitting from the first lens array 140d vary based on the positions. The collimation lights L2 are drawn close towards the first aligning center AL1 where the phase center C2 and the optical fiber core C1 thereon have a smallest drift.

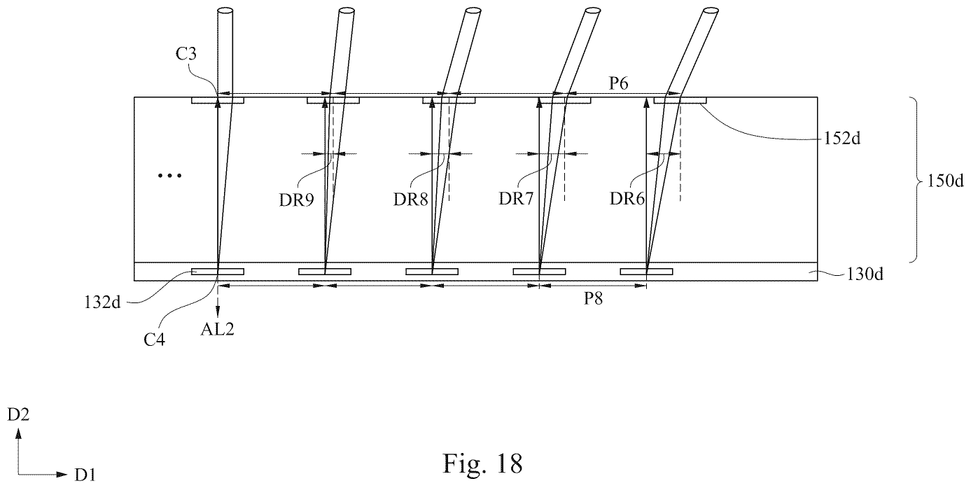

FIG. 18 is an enlarged view of the second lens array 150d and the photonic integrated circuit 130d in FIG. 16. Reference is made to FIG. 15C and FIG. 18. FIG. 18 is an example of five groups in the lens region R7 of the second lens array 150d in FIG. 15C. The positions closest to the array center of the grating coupler array 132d and the second lens array 150d are aligned or are closest. As shown in FIG. 18, the phase center C3 and the transceiver core C4 at the most left side in the lens region R7 have a smallest drift (it's aligned as an example), and the position herein is defined as a second aligning center AL2.

As the distances relative to the second aligning center AL2 are larger, the drifts between the phase centers C3 and the transceiver cores C4 are larger. For example, the phase center C3 and the transceiver core C4 at the most right side in FIG. 18 have a larger drift DR6. Similarly, the phase center C3 and the transceiver core C4 outside the lens region R7 of the second lens array 150d have even greater drift (not shown). Accordingly, the drifts of the phase centers C3 of the second light adjusting elements 152d and the transceiver cores C4 along the horizontal direction D1 form a second drift distribution, which gradually increase relative to the second aligning center AL2 (0<DR9<DR8<DR7<DR6).

Reference is made to FIG. 16. The first aligning center AL1 and the second aligning center AL2 have a misalignment. In other embodiment, the first aligning center AL1 and the second aligning center AL2 can be aligned. In other words, the optical fiber array unit 120d and the grating coupler array 132d with different specifications can be coupled as an array through the relative displacement between the first aligning center AL1 and the second aligning center AL2.

In the following description, a manufacturing method of the multi-channel optical fiber transmission interface will be described. It is to be noted that the connection relation, material, and advantages of the above elements will not be described repeatedly.

The manufacturing method of the multi-channel optical fiber transmission interface is applied to the embodiments shown in FIG. 1, FIG. 8, FIG. 13, and FIG. 14 that contain a first lens array and a second lens array, and the embodiment in FIG. 1 is used as an example.

The manufacturing method of the multi-channel optical fiber transmission interface begins with forming the grating coupler array 132 in the photonic integrated circuit 130. Subsequently, dispose the optical fiber array unit 120 such that the transceiver end surface 122 of the optical fiber array unit 120 faces the grating coupler array 132.

Subsequently, dispose the first lens array 140 and the second lens array 150 between the grating coupler array 132 and the optical fiber array unit 120 to couple a light. As shown in FIG. 3, the first lens array 140 and the second lens array 150 are pluggable through the coupling structure 160. In this step, the meta-lens, micro-lens, diffractive element or plasmonic element are disposed as the first light adjusting elements 142 and the second light adjusting elements 152.

Reference is made to FIG. 3. In one embodiment, when the optical fiber interval P3 of the optical fiber array unit 120 is equal to the coupler interval P4 of the grating coupler array 132, align the phase centers C2 of the first light adjusting elements 142 respectively with the optical fiber cores C1 of the optical fibers 110 along the vertical direction D2 and align the phase centers C3 of the second light adjusting elements 152 respectively with the transceiver centers C4 of the grating coupler array 132 along the vertical direction D2 (illustrated by dashed line along the vertical direction D2). The first interval P1 is equal to the second interval P2. Subsequently, adjusting the relative displacement between the first lens array 140 and the second lens array 150 along the horizontal direction D1 based on the inclined angle of the optical fibers 110. For example, different relative displacements between the first lens array and the second lens array along the horizontal direction D1 when the optical fibers have different incident angles are demonstrated in aforementioned FIG. 3, FIG. 6, and FIG. 7.

Reference is made to FIG. 16. In another embodiment, when the optical fiber interval P7 of the optical fiber array unit 120d is not equal to the coupler interval P8 of the grating coupler array 132, make the optical fiber interval P7 greater than the first interval P5 of the first lens array 140d, the first interval P5 of the first lens array 140d greater than or equal to the second interval P6 of the second lens array 150d, and the second interval P6 of the second lens array 150d greater than the coupler interval P8. Subsequently, reference is made to FIG. 17, make the first drift distribution of the phase centers C2 of the first light adjusting elements 142d and the optical fiber cores C1 gradually increase relative to the first aligning center AL1. Similarly, reference is made to FIG. 18, make the second drift distribution of the phase centers C3 of the second light adjusting elements 152d and the transceiver centers C4 gradually increase relative to the second aligning center AL2. In addition, adjusting the relative displacement between the first aligning center AL1 and the second aligning center AL2. With aforementioned steps, the optical fiber array unit 120d and the grating coupler array 132d with different specifications can be matched based on scale through the first lens array 140d and the second lens array 150d to adapt the trend of gradually decreasing coupler interval due to the process improvement of the photonic integrated circuit 130.

In summary, the multi-channel optical fiber transmission interface of the present disclosure can couple the lights from multiple optical fibers to the grating coupler array of the photonic integrated circuit simultaneously through the first lens array and the second lens array, and therefore the data transmission rate can be improved and the power dissipation can be reduced to 1 pJ/bit simultaneously in the co-packaged technique to provide computing and transmission requirements for generative AI technique. Or, coupling the lights to the grating coupler array through a lens array connected with the optical fiber array unit. In addition, the first lens array and the second lens array are pluggable, which can be compatible with different requirements of optical fibers and grating couplers. A distance is maintained between the first lens array and the second lens array, damages to the first lens array and the second lens array caused by gathered dust when the first lens array and the second lens array are being plugged and unplugged repeatedly can be avoided. The lights with different incident angles can be focused on the grating coupler array simultaneously as an array through the relative displacement between the first lens array and the second lens array along the horizontal direction. When the optical fiber interval is not equal to the coupler interval, make the first drift distribution of the phase centers of the first light adjusting elements and the optical fiber cores gradually increase relative to the first aligning center, and make the second drift distribution of the phase centers of the second light adjusting elements and the transceiver centers of the grating coupler array gradually increase relative to the second aligning center. As such, the optical fiber array unit and the grating coupler array with different specifications can be matched based on scale through the first lens array and the second lens array to adapt the trend of gradually decreasing coupler interval due to the process improvement of the photonic integrated circuit.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A multi-channel optical fiber transmission interface, comprising:
a plurality of optical fibers;
an optical fiber array unit configured to connect the optical fibers, wherein the optical fiber array unit comprises a transceiver end surface;
a photonic integrated circuit comprising a grating coupler array, wherein the transceiver end surface of the optical fiber array unit faces the grating coupler array;
a first lens array located between the grating coupler array and the optical fiber array unit and configured to connect the transceiver end surface of the optical fiber array unit; and
a second lens array located between the grating coupler array and the first lens array, wherein the second lens array is opposite to the first lens array and is configured to adjust the collimation and alignment of the light.

2. The multi-channel optical fiber transmission interface of claim 1, wherein the second lens array is integrated in the photonic integrated circuit.

3. The multi-channel optical fiber transmission interface of claim 1, wherein the first lens array comprises a plurality of first light adjusting elements, the second lens array comprises a plurality of second light adjusting elements, the first light adjusting elements and the second light adjusting elements have a width, and the width is in a range from 50 μm to 250 μm.

4. The multi-channel optical fiber transmission interface of claim 1, wherein the first lens array comprises a plurality of first light adjusting elements, the second lens array comprises a plurality of second light adjusting elements, the first light adjusting elements have a first interval therebetween, the second light adjusting elements have a second interval therebetween, and the first interval and the second interval are in a range from 50 μm to 250 μm.

5. The multi-channel optical fiber transmission interface of claim 1, wherein the first lens array and the second lens array comprise meta-lens, micro-lens, diffractive element or plasmonic element.

6. The multi-channel optical fiber transmission interface of claim 5, wherein the meta-lens comprises a plurality of nanostructures, a feature size of the nanostructures is in a range from 10 nm to 750 nm.

7. The multi-channel optical fiber transmission interface of claim 1, wherein the first lens array comprises a first surface facing the second lens array, the second lens array comprises a second surface facing the first lens array, the first surface and the second surface have a distance therebetween, and the distance is in a range greater than 0 μm and smaller than 1000 μm.

8. The multi-channel optical fiber transmission interface of claim 1, wherein the first lens array comprises a third surface facing the optical fiber array unit and a first optical coating layer located on the third surface, the second lens array comprises a fourth surface facing the photonic integrated circuit and a second optical coating layer located on the fourth surface, the first optical coating layer and the second optical coating layer comprise one of an anti-reflection layer and a refractive index matching layer or a combination thereof.

9. The multi-channel optical fiber transmission interface of claim 1, wherein the optical fibers comprise at least one of a single mode fiber and a polarization-maintaining fiber.

10. The multi-channel optical fiber transmission interface of claim 1, wherein the optical fibers have an optical fiber interval therebetween, the grating coupler array comprises a plurality of grating couplers, the grating couplers have an coupler interval therebetween, the first lens array comprises a plurality of first light adjusting elements, the second lens array comprises a plurality of second light adjusting elements, the first light adjusting elements have a first interval therebetween, and the second light adjusting elements have a second interval therebetween; wherein
when the optical fiber interval is equal to the coupler interval, a plurality of phase centers of the first light adjusting elements are respectively aligned with a plurality of optical fiber cores of the optical fibers and a plurality of phase centers of the second light adjusting elements are respectively aligned with a plurality of transceiver centers of the grating couplers;
when the optical fiber interval is not equal to the coupler interval, the optical fiber interval is greater than the first interval of the first lens array, the first interval of the first lens array is greater than or equal to the second interval of the second lens array, and the second interval of the second lens array is greater than the coupler interval.

11. A multi-channel optical fiber transmission interface, comprising:
a plurality of optical fibers;
an optical fiber array unit configured to connect the optical fibers;
a photonic integrated circuit comprising a grating coupler array; and
a lens array connecting the optical fiber array unit and located above the photonic integrated circuit, wherein the lens array is located between the grating coupler array and the optical fiber array unit, the lens array is opposite to the grating coupler array and configured to couple the light.

12. The multi-channel optical fiber transmission interface of claim 11, wherein the grating coupler array comprises a plurality of transceiver ports having large mode field diameter, and a mode width of the light in the transceiver ports is in a range from 15 μm to 100 μm.

13. The multi-channel optical fiber transmission interface of claim 11, wherein the lens array comprises meta-lens, micro-lens, diffractive element or plasmonic element.

14. The multi-channel optical fiber transmission interface of claim 11, further comprising:
a coupling structure disposed between a first surface of the lens array facing the photonic integrated circuit and a second surface of the photonic integrated circuit facing the lens array, the coupling structure is configured to make a distance between the first surface and the second surface greater than 0 μm and smaller than 1000 μm.

15. The multi-channel optical fiber transmission interface of claim 11, wherein the lens array comprises a third surface facing the optical fiber array unit and an optical coating located on the third surface, and a thickness of the optical coating is smaller than 150 μm.

16. The multi-channel optical fiber transmission interface of claim 11, wherein the optical fibers comprise at least one of a single mode fiber and a polarization-maintaining fiber.

17. A manufacturing method of a multi-channel optical fiber transmission interface, comprising:
forming a grating coupler array in a photonic integrated circuit;
disposing an optical fiber array unit such that a transceiver end surface of the optical fiber array unit faces the grating coupler array; and
disposing a first lens array and a second lens array between the grating coupler array and the optical fiber array unit to couple a light, such that the first lens array or the second lens array is pluggable, wherein the first lens array comprises a plurality of first light adjusting elements, and the second lens array comprises a plurality of second light adjusting elements; wherein
when an optical fiber interval of the optical fiber array unit is equal to a coupler interval of the grating coupler array, align a plurality of phase centers of the first light adjusting elements respectively with a plurality of optical fiber cores of a plurality of optical fibers along a vertical direction and align a plurality of phase centers of the second light adjusting elements respectively with a plurality of transceiver centers of the grating coupler array;
when the optical fiber interval is not equal to the coupler interval, the phase centers of the first light adjusting elements and the optical fiber cores have a first drift distribution along a horizontal direction, a position of the smallest one in the first drift distribution is a first aligning center, and the first drift distribution gradually increase relative to the first aligning center, wherein the phase centers of the second light adjusting elements and a plurality of transceiver centers of the grating coupler array have a second drift distribution along the horizontal direction, a position of the smallest one in the second drift distribution is a second aligning center, and the second drift distribution gradually increase relative to the second aligning center.

18. The manufacturing method of a multi-channel optical fiber transmission interface of claim 17, further comprising:
adjusting a relative displacement between the first lens array and the second lens array along the horizontal direction based on an inclined angle of the optical fibers.

19. The manufacturing method of a multi-channel optical fiber transmission interface of claim 17, wherein when the optical fiber interval is not equal to the coupler interval, further comprises:
making the optical fiber interval greater than a first interval of the first lens array, the first interval of the first lens array greater than or equal to a second interval of the second lens array, the second interval of the second lens array greater than the coupler interval, and making the optical fiber interval and the coupler interval in a range from 50 μm to 250 μm.

20. The manufacturing method of a multi-channel optical fiber transmission interface of claim 17, wherein disposing the first lens array and the second lens array further comprises:
forming meta-lens, micro-lens, diffractive element or plasmonic element.
